(19) United States
(12) Patent Application Publication
(10) Pub. No.: US 2007/0083758 A1
(43) Pub. Date: Apr. 12, 2007

(54) Data transfer device

(76) Inventors: Andrew Topham, Stoke Gifford (GB); John William Drew, Stoke Gifford (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/493,909

(22) Filed: Jul. 25, 2006

(30) Foreign Application Priority Data
Oct. 11, 2005 (GB) 0520603.2

(51) Int. Cl. H04L 9/00

(52) U.S. Cl. 713/168

(57) ABSTRACT

A data transfer device for storing data to a removable data storage item. The data transfer device comprises a non-volatile memory suitable for storing an encryption key. Unauthorised access to the contents of the non-volatile memory is prevented. The data transfer device is operable to receive data to be stored, encrypt the data using an encryption key stored in the non-volatile memory and a seed value derived from information obtained from the removable data storage item, and store the encrypted data to the removable data storage item.

### FIELD OF THE INVENTION

The present invention relates to a data transfer device for storing data to and retrieving data from a removable data storage item, wherein data are encrypted or decrypted by the data transfer device during data storage and data retrieval.

### BACKGROUND OF THE INVENTION

Data backup is a valuable tool in safeguarding important data. Data are generally backed-up onto removable data storage items, such as tape cartridges or optical discs, such that the backup data may be stored at a different geographical location to the primary data.

By storing important data onto removable data storage items, security issues become a consideration. For example, a visitor to a site might easily pocket a tape cartridge storing large amounts of commercially sensitive data.

Many backup software packages provide the option of encrypting data prior to backup. However, software encryption increases the time required to backup data and consumes valuable computer resources.

### SUMMARY OF THE INVENTION

The present invention provides a data transfer device for storing data to a removable data storage item, the data transfer device comprising a non-volatile memory suitable for storing an encryption key, wherein unauthorised access to the contents of the non-volatile memory is prevented or resisted and the data transfer device is operable to: receive data to be stored; encrypt the data using an encryption key stored in the non-volatile memory and a seed value derived from information obtained from the removable data storage item; and store the encrypted data to the removable data storage item.

Preferably, the non-volatile memory stores an encryption key.

Conveniently, the data transfer device is operable to receive an encryption key, and store the encryption key in the non-volatile memory.

Advantageously, the data transfer device is operable to receive a further encryption key and to replace the encryption key stored in the non-volatile memory with the further encryption key.

Conveniently, the information is unique to the removable data storage item such that the data transfer device is operable to employ different seed values for different removable data storage items.

Advantageously, the information comprises a serial number of the removable data storage item.

Another aspect of the invention provides a data transfer device for retrieving and outputting data from a removable data storage item, the data transfer device comprising a non-volatile memory suitable for storing a decryption key, wherein unauthorised access to the contents of the non-volatile memory is prevented and the data transfer device is operable to: retrieve data from the removable data storage item; decrypt the data using a decryption key stored in the non-volatile memory and a seed value derived from information obtained from the removable data storage item; and output the decrypted data.

Advantageously, the non-volatile memory stores a decryption key.

Preferably, the data transfer device is operable to receive a decryption key, and store the decryption key in the non-volatile memory.

Conveniently, the data transfer device is operable to receive a further decryption key and to replace the decryption key stored in the non-volatile memory with the further decryption key.

Preferably, the information is unique to the removable data storage item such that the data transfer device is operable to employ different seed values for different removable data storage items.

Conveniently, the information comprises a serial number of the removable data storage item.

A further aspect of the invention provides a data transfer device for exchanging data between a host device and a removable data storage item, the data transfer device comprising a non-volatile memory suitable for storing an encryption key, wherein unauthorised access to the contents of the non-volatile memory is prevented and the data transfer device is operable to: receive data from the host device; encrypt the data using an encryption key stored in the non-volatile memory and a seed value derived from information obtained from the removable data storage item; store the encrypted data to the removable data storage item; retrieve the encrypted data from the removable data storage item; decrypt the encrypted data using the encryption key stored in the non-volatile memory and the seed value derived from information obtained from the removable data storage item; and output the decrypted data to the host device.

Another aspect of the invention provides a data transfer device for storing data to a removable data storage item, the data transfer device comprising: means for storing an encryption key, wherein unauthorised access to the means for storing is prevented; means for receiving data to be stored; means for encrypting the data using the encryption key and a seed value derived from information obtained from the removable data storage item; and means for storing the encrypted data to the removable data storage item.

A still further aspect of the invention provides a data transfer device for retrieving and outputting data from a removable data storage item, the data transfer device comprising: means for storing a decryption key, wherein unauthorised access to the means for storing is prevented; means for retrieving data from the removable data storage item; means for decrypting the data using the decryption key and a seed value derived from information obtained from the removable data storage item; and means for outputting the decrypted data.

Preferably, the data transfer device is a tape drive and the removable data storage item is a tape cartridge.

Another aspect of the invention provides a method of storing data to a removable data storage item, the method comprising: receiving data to be stored; encrypting the data using an encryption key and a seed value derived from information obtained from the removable data storage item; and storing the encrypted data to the removable data storage item.

A still further aspect of the invention provides a method of retrieving and outputting data from a removable data storage item, the method comprising: retrieving data from the removable data storage item; decrypting the data using a decryption key and a seed value derived from information obtained from the removable data storage item; and outputting the decrypted data.

Preferably, the method comprises obtaining the information from the removable data storage item.

Advantageously, the information is unique to the removable data storage item such that the different seed values are used for different removable data storage items.

Conveniently, the information comprises a serial number of the removable data storage item.

In a further aspect, the present invention provides a computer program product storing computer program code executable by a data transfer device, the computer program product when executed causing the data transfer device to operate as described in the aforementioned aspects of the invention, or to perform the aforementioned methods.

### BRIEF DESCRIPTION OF THE DRAWINGS

In order that the present invention may be more readily understood, embodiments thereof will now be described, by way of example, with reference to the accompanying drawings, in which:

FIG. 1 is a schematic block diagram of a tape drive embodying the present invention.

### DETAILED DESCRIPTION

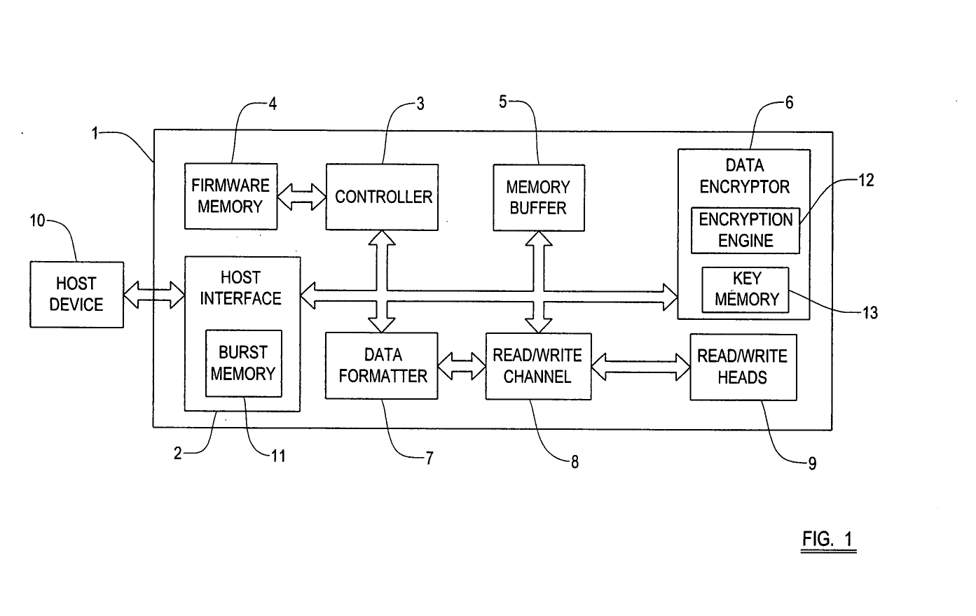

The tape drive 1 of FIG. 1 comprises a host interface 2, a controller 3, firmware memory 4, a memory buffer 5, a data encryptor 6, a data formatter 7, a read/write channel 8, and magnetic read/write heads 9.

With the exception of the data encryptor 6 and the software stored in the firmware memory 4, the components of the tape drive 1 are identical to those employed in conventional tape drives.

The host interface 2 controls the exchange of data between the tape drive 1 and a host device 10. Control signals received from the host device 9 by the interface 2 are delivered to the controller 3, which, in response, controls the operation of the tape drive 1. Data received from the host device 10 typically arrives in high-speed bursts and the host interface 2 includes a burst memory 11 for temporarily storing data received from the host device 10.

The controller 3 comprises a microprocessor, which executes instructions stored in the firmware memory 4 to control the operation of the tape drive 1. The data encryptor 6 comprises an encryption engine 12 and a key memory 13. The encryption engine 12 employs a symmetric encryption algorithm to encrypt and decrypt data using an encryption key. The key memory 13 is a non-volatile memory that stores an encryption key used by the encryption engine 12 to encrypt and decrypt data.

In response to a write command received from the host device 9 by the controller 3, data stored in burst memory 11 are retrieved by the data encryptor 6. The data encryptor 6 then encrypts the data using the encryption engine 12 and the encryption key stored in the key memory 13. The encrypted data are then stored by the data encryptor 6 in the memory buffer 5.

The controller 3 or data encryptor 6 may optionally embed or append error control coding or redundancy data to the data received from the host device 10 prior to encryption. For example, a CRC may be appended to the data prior to encryption. As detailed below, the inclusion of redundancy data enables the tape drive 1 to determine whether encrypted data later retrieved from tape have been successfully decrypted.

The data formatter 7 formats the encrypted data into a format suitable for writing to tape. Typically, the data formatter 7 ECC-encodes the encrypted data, randomises the ECC-encoded data to remove long sequences, and RLL encodes the randomised data. The formatted data are then processed by the read/write channel 8, which converts the formatted data into electrical signals for driving the magnetic read/write heads 9.

The read process is basically the reverse of the write process. In response to a read command received from the host device 10 by the controller 3, the magnetic read/write heads 9 are caused to pass over the relevant portion of the tape on which the requested data are stored. The resulting analogue signal is delivered to the read/write channel 8, which converts the analogue signal into digital data, which are then unformatted (e.g. decoded) by the data formatter 7 and stored in the memory buffer 5. The data encryptor 6 then decrypts the data stored in the memory buffer using the encryption engine 12 and the encryption key stored in key memory 13. The decrypted data are then delivered to the host device 11 via the interface 2.

As noted above, the controller 3 or data encryptor 6 optionally embeds or appends redundancy data to the data to be stored prior to encryption. In this optional embodiment, the controller 3 or data encryptor 6 checks the redundancy data following data decryption to ascertain whether the decryption process was successful. If the redundancy data of the decrypted data do not correspond to that expected, the controller 3 delivers an error signal to the host device 12 via the interface 2 to indicate that the requested data could not be successfully decrypted. Unsuccessful decryption may arise because the wrong decryption key was used to decrypt the data and/or the encrypted data read from tape were corrupt.

Importantly, the contents of the key memory 13 are inaccessible by the host device 10. In particular, access to the key memory 13 is possible only by the encryption engine 12. Consequently, it is not possible for unauthorised users to obtain a copy of the encryption key.

The encryption key is stored to the key memory 13 during manufacture of the tape drive 1. Each tape drive includes a unique serial number. During manufacture, the encryption key stored to the key memory 13 of a particular tape drive 1 is recorded in a secure database along with the serial number of the tape drive 1. Should a user require a replacement tape drive, or an additional tape drive having the same encryption key, the user supplies the manufacturer with the serial number of his present tape drive. The manufacturer is then able to lookup and retrieve the corresponding encryption key from the secure database and store the encryption key to the key memory 5 of the replacement or additional tape drive. At no time, however, is the user provided with a copy of the encryption key that is not embedded in a tape drive.

In an another embodiment, the tape drive 1 is manufactured without any encryption key being stored in the key memory 13. A software package containing the encryption key is then provided separately to the owner of the tape drive 1. The software package is executable by the host device 10 and causes an encryption key to be stored to the key memory 13, e.g. by means of a special command issued by the host device 10 to the controller 3. In this way, encryption keys can be managed and provided by a trusted third party who is independent of the tape drive manufacturer.

Whilst in this alternative embodiment, the contents of the key memory 13 may be overwritten, it continues to remain impossible for the contents of the key memory 13 to be read by the host device 10.

The use of a singe encryption key to store data to many different tape cartridges may compromise the security of the encrypted data. Accordingly, the encryption engine 12 may employ an algorithm that employs both the encryption key stored in key memory 13 and also a varying seed value to encrypt the data. The seed value is ideally derived from information unique to each tape cartridge, such as the tape cartridge serial number.

In the embodiments described above, the encryption engine 12 employs a symmetric encryption algorithm and the key memory 13 stores a single encryption key that is used for both encryption and decryption of data. Alternatively, however, the encryption engine 12 may employ an asymmetric encryption algorithm, with the key memory 13 storing an encryption key and a separate decryption key.

Although embodiments of the present invention have been described with reference to a tape drive 1, it will be appreciated that the present invention is equally applicable to other types of data transfer devices, such as optical drives, in which data are stored to removable data storage items (e.g. CDs, DVDS).

With the data transfer device embodying the present invention, the encryption and decryption of backup data is moved from the host device to the data transfer device. The data transfer device does not rely upon special commands or control signals in order to encrypt or decrypt data, but instead encrypts and decrypts data in response to conventional read and write commands received from the host device. Accordingly, the data transfer device is capable of operating using standard hardware interfaces such as SCSI, FibreChannel, SAS, PCI, IDE, EISA, USB, FireWire®, Bluetooth®, IrDA etc. By storing an encryption key in non-volatile memory within the data transfer device, there is no need for the owner of the device to manage encryption keys. Moreover, as the encryption key is inaccessible, the security of data stored by the data transfer device to removable data storage items is assured.

When used in this specification and claims, the terms “comprises” and “comprising” and variations thereof mean that the specified features, steps or integers are included. The terms are not to be interpreted to exclude the presence of other features, steps or components.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

What is claimed is:

1. A data transfer device for storing data to a removable data storage item, the data transfer device comprising a non-volatile memory suitable for storing an encryption key, wherein unauthorised access to the contents of the non-volatile memory is prevented and the data transfer device is operable to:
receive data to be stored;
encrypt the data using an encryption key stored in the non-volatile memory a seed value derived from information obtained from the removable data storage item; and
store the encrypted data to the removable data storage item.

2. A data transfer device according to claim 1, wherein the non-volatile memory stores an encryption key.

3. A data transfer device according to claim 1, wherein the data transfer device is operable to receive an encryption key, and store the encryption key in the non-volatile memory.

4. A data transfer device according to claim 3, wherein the data transfer device is operable to receive a further encryption key and to replace the encryption key stored in the non-volatile memory with the further encryption key.

5. A data transfer device according to claim 1, wherein the information is unique to the removable data storage item such that the data transfer device is operable to employ different seed values for different removable data storage items.

6. A data transfer device according to claim 5, wherein the information comprises a serial number of the removable data storage item.

7. A data transfer device according to claim 1, wherein the data transfer device is suitable for retrieving and outputting data from the removable data storage item, and the data transfer device is operable to:
retrieve encrypted data from the removable data storage item;
decrypt the encrypted data using the encryption key stored in the non-volatile memory and the seed value derived from information obtained from the removable data storage item; and
output the decrypted data.

8. A data transfer device according to claim 1, wherein the data transfer device is a tape drive and the removable data storage item is a tape cartridge.

9. A data transfer device for storing data to a removable data storage item, the data transfer device comprising:
means for storing an encryption key, wherein unauthorised access to the means for storing is prevented;
means for receiving data to be stored;
means for encrypting the data using the encryption key and a seed value derived from information obtained from the removable data storage item; and
means for storing the encrypted data to the removable data storage item.

10. A data transfer device according to claim 9, wherein the data transfer device is suitable for retrieving and outputting data from the removable data storage item, and the data transfer device comprises:
means for storing a decryption key, wherein unauthorised access to the means for storing is prevented;
means for retrieving data from the removable data storage item;
means for decrypting the data using the decryption key a seed value derived from information obtained from the removable data storage item; and
means for outputting the decrypted data.

11. A method of storing data to a removable data storage item, the method comprising:
receiving data to be stored;
encrypting the data using an encryption key and a seed value derived from information obtained from the removable data storage item; and
storing the encrypted data to the removable data storage item.

12. A method according to claim 11, wherein the method is suitable for retrieving and outputting data from the removable data storage item, and the method comprises:
retrieving encrypted data from the removable data storage item;
decrypting the encrypted data using the encryption key and the seed value; and
outputting the decrypted data.

13. A method according to claim 11, wherein the method comprises: obtaining the information from the removable data storage item.

14. A method according to claim 11, wherein the information is unique to the removable data storage item such that the different seed values are used for different removable data storage items.

15. A method according to claim 14, wherein the information comprises a serial number of the removable data storage item.
